(19) United States
(12) Patent Application Publication
(10) Pub. No.: US 2023/0230265 A1
(43) Pub. Date: Jul. 20, 2023

(54) METHOD AND APPARATUS FOR PATCH GAN-BASED DEPTH COMPLETION IN AUTONOMOUS VEHICLES

(71) Applicant: FOUNDATION OF SOONGSIL UNIVERSITY-INDUSTRY COOPERATION, Seoul (KR)

(72) Inventors: Myung Sik YOO, Seoul (KR); Minh Tri NGUYEN, Seoul (KR)

(73) Assignee: FOUNDATION OF SOONGSIL UNIVERSITY-INDUSTRY COOPERATION, Seoul (KR)

(21) Appl. No.: 18/098,940

(22) Filed: Jan. 19, 2023

(30) Foreign Application Priority Data
Jan. 20, 2022 (KR) 10-2022-0008218

(51) Int. Cl. G06T 7/55; G06V 20/56; G06N 3/0475

(52) U.S. Cl. CPC G06T 7/55; G06V 20/56; G06N 3/0475; G06T 2207/20084

(57) ABSTRACT

Provided are a patch GAN-based depth completion method and apparatus in an autonomous vehicle. The patch-GAN-based depth completion apparatus according to the present invention comprises a processor; and a memory connected to the processor, wherein the memory stores program instructions executable by the processor for performing operations in a generating unit of a generative adversarial neural network comprising a first branch and a second branch based on an encoder-decoder comprising receiving an RGB image and a sparse image through a camera and LiDAR, generating a dense first depth map by processing color information of the RGB image through the first branch, generating a dense second depth map by up-sampling the sparse image through the second branch, generating a dense final depth map by fusing the first depth map and the second depth map, and determining, by a discriminating unit of the generative adversarial neural network, whether the final depth map is fake or real by dividing the final depth map and depth measurement data into a plurality of patches.

### CROSS-REFERENCE TO RELATED APPLICATIONS

This application claims the benefit of Korean Application No. 10-2022-0008218, filed Jan. 20, 2022, in the Korean Intellectual Property Office. All disclosures of the document named above are incorporated herein by reference.

### TECHNICAL FIELD

The present invention relates to a patch GAN-based depth completion method and apparatus in an autonomous vehicle.

### BACKGROUND ART

A high-precision depth image is important for a variety of functions in autonomous vehicles, such as 3D object detection, map reconstruction, or route planning.

In particular, depth completion is an essential function in autonomous vehicle sensing systems.

LiDAR (Light Detection and Ranging) is a sensor that acquires distance information with an object based on the time it takes for a laser beam to be reflected and returned to an object after emitting it.

However, since the LiDAR only uses a small number of laser beams due to cost issues, the collected data is very sparse.

Also, due to the shape of the laser when scanning a region that includes the edge or boundary of an object, only a portion of the laser beam hits the object and bounces back. Therefore, in some cases, it may not deliver enough energy to reach the sensor. As a result, LiDAR loses information in that region and the entire data is unstructured, which makes it difficult to perform vision tasks such as object detection, object tracking and location identification.

### [Patent Literature]

Korean Patent Application Publication No. 10-2021-0073416

### DISCLOSURE

### [Technical Problem]

In order to solve the problems of the prior art, the present invention proposes a patch GAN-based depth completion method and apparatus in an autonomous vehicle that can improve performance.

### [Technical Solution]

In order to achieve the above object, according to an embodiment of the present invention, a patch-GAN based depth completion apparatus comprises a processor; and a memory connected to the processor, wherein the memory stores program instructions executable by the processor for performing operations in a generating unit of a generative adversarial neural network comprising a first branch and a second branch based on an encoder-decoder comprising receiving an RGB image and a sparse image through a camera and LiDAR, generating a dense first depth map by processing color information of the RGB image through the first branch, generating a dense second depth map by up-sampling the sparse image through the second branch, generating a dense final depth map by fusing the first depth map and the second depth map, and determining, by a discriminating unit of the generative adversarial neural network, whether the final depth map is fake or real by dividing the final depth map and depth measurement data into a plurality of patches.

The first encoder of the first branch and the second encoder of the second branch may include a plurality of layers, and the first and second encoders may include a convolutional layer and a plurality of residual blocks having a skip connection.

Each layer of the first encoder may be connected to each layer of the second encoder to help preserve rich features of the RGB image.

The discriminating unit may divide the final depth map and the depth measurement data into matrices of N×N size, and may evaluate whether each N×N patch is real or fake.

The image obtained by combining the RGB image with the final depth map and the depth measurement data may be input to the discriminating unit.

According to other embodiment of the present invention, a patch-GAN-based depth completion method in an apparatus including a processor and a memory comprises, in a generating unit of a generative adversarial neural network comprising a first branch and a second branch based on an encoder-decoder comprising, receiving an RGB image and a sparse image through a camera and LiDAR, generating a dense first depth map by processing color information of the RGB image through the first branch, generating a dense second depth map by up-sampling the sparse image through the second branch, generating a dense final depth map by fusing the first depth map and the second depth map, and determining, by a discriminating unit of the generative adversarial neural network, whether the final depth map is fake or real by dividing the final depth map and depth measurement data into a plurality of patches.

According to another embodiment of the present invention, a computer-readable recording medium stores a program for performing the above method.

### [Advantageous Effects]

According to the present invention, it has the advantage of increasing the depth completion performance by fusing two sensors at multi levels and using a generative adversarial network (GAN) model.

### DESCRIPTION OF DRAWINGS

These and/or other aspects will become apparent and more readily appreciated from the following description of the embodiments, taken in conjunction with the accompanying drawings in which:

FIG. 1 is a diagram illustrating a depth completion architecture according to a preferred embodiment of the present invention;

FIG. 2 is a diagram showing the detailed structure of a generating unit according to the present embodiment;

FIG. 3 is a diagram showing a detailed structure of a discriminating unit according to the present embodiment; and

FIG. 4 is a diagram showing the configuration of a patch GAN-based depth completion apparatus according to the present embodiment.

### DETAILED DESCRIPTION OF EMBODIMENTS

Since the present invention can make various changes and have various embodiments, specific embodiments are illustrated in the drawings and described in detail.

However, this is not intended to limit the present invention to specific embodiments, and should be understood to include all modifications, equivalents, and substitutes included in the spirit and technical scope of the present invention.

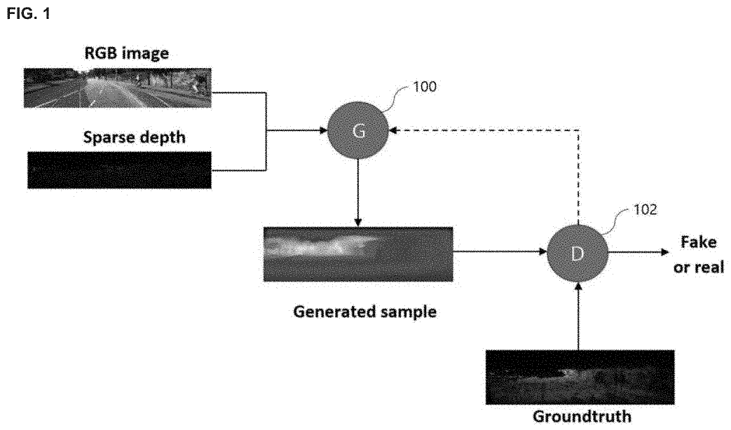

FIG. 1 is a diagram illustrating a depth completion architecture according to a preferred embodiment of the present invention.

As shown in FIG. 1, depth completion according to the present embodiment may be performed through a generative adversary network including a generating unit 100 and a discriminating unit 102.

The generating unit 100 generates a virtual dense depth map by using an RGB image captured by a camera and a sparse image obtained by a LiDAR as inputs.

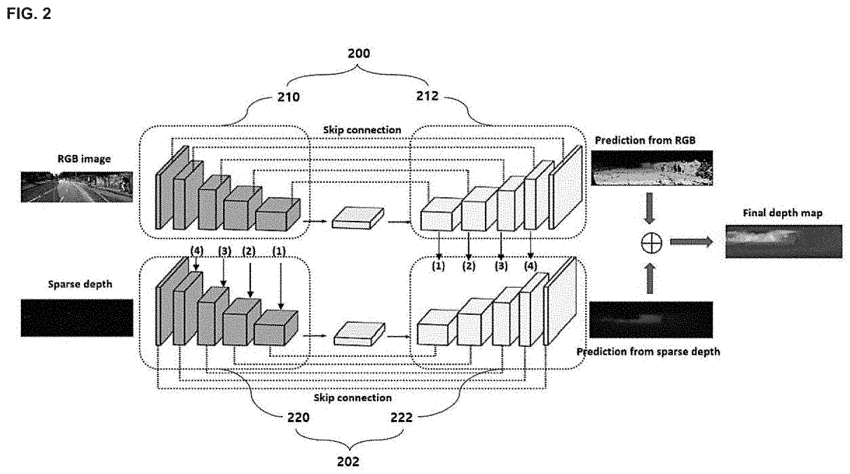

FIG. 2 is a diagram showing the detailed structure of a generating unit according to the present embodiment.

As shown in FIG. 2, the generating unit 100 according to the present embodiment includes two branches, and each branch is composed of an encoder-decoder architecture.

The first branch (color-branch) 200 is defined as a color branch, and processes color information from an RGB image, which is an input captured through a camera, to generate a dense first depth map (Prediction from RGB), and the second branch (depth-branch) 202 performs an up-sampling procedure on the sparse image to generate a dense second depth map (Prediction from sparse depth).

The first encoder 210 of the first branch 200 includes a plurality of layers, the first layer includes a convolution layer and then may include a plurality of residual blocks with skip connections.

The first decoder 212 of the first branch 200 is designed with 5 up-sampling blocks, but instead of using the conventional transpose convolution which generates heavy checker artifacts in the resulting image, includes the resize convolution.

The resize convolution layer comprises a nearest-neighbor up-sampling layer following the convolution layer. BatchNorm layers and ReLU activation layers are placed contiguously after all convolutional layers. A skip connection between an encoder 210 and a decoder 212 is used to prevent vanishing gradients in deep networks.

The second branch 102 takes a sparse image as an input and up-samples it to generate a dense second depth map.

The sparse image is generated by converting the spherical coordinate system related to the geometric information of the point obtained through the LiDAR into the cartesian coordinate system and projecting it onto the image plane.

The second branch 202 also includes an encoder-decoder (second encoder 220, second decoder 222) architecture.

When down-sampling the depth information in the second branch 202, the bottleneck layer loses all information because the input is very sparse and unstructured. In order to solve this problem, according to the present embodiment, each layer of the first encoder 210 is connected with each layer of the second encoder 220 to help preserve the rich features of the RGB image ((1) to (4)).

The output results of the first branch 100 and the second branch 102 are two dense depth maps (Prediction from RGB/Prediction from sparse depth), and then a final depth map is output through fusion therefrom.

The final depth map can be generated via FusionNet.

Thereafter, the discriminating unit 102 determines whether the virtual final depth map is fake or real by taking the virtual final depth map and depth measurement data (depth groundtruth) as inputs.

Since the final depth map generated by the generating unit 100 should have texture and scene structure similar to that of the RGB image, the discriminating unit 102 according to the present embodiment performs a determining process based on patch GAN.

The patch GAN divides the input image into matrices of N×N size, which are defined as patches.

The discriminating unit 102 then evaluates whether each N×N patch of the input image is real or fake.

This has two advantages.

First, the number of parameters in the model is much smaller compared to conventional discriminating units, which require more convolutional layers to output a single scalar value.

Second, since the evaluation of the discriminating unit 102 is performed on different regions of the generated image, it can help produce high-resolution results.

Compared with the virtual final depth map generated by the generating unit 100, the depth measurement data has only about 30% of effective pixels including the depth value, and the rest are displayed as invalid pixels having a depth value of 0.

As a result, when the discriminating unit 102 is configured as a convolutional layer and each patch of an image is evaluated, the generated virtual final depth map and depth measurement data may operate differently.

To compensate for this problem, the RGB image is combined (concat) with both the final depth map and the depth measurement data.

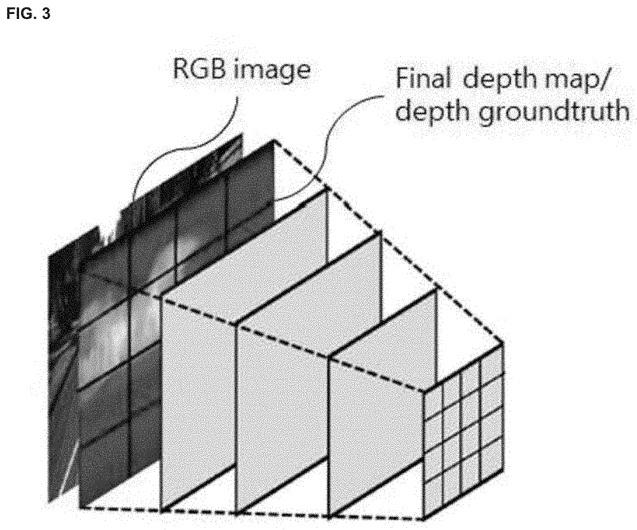

FIG. 3 is a diagram showing a detailed structure of a discriminating unit according to the present embodiment.

Depth loss according to the present embodiment is as follows.

[symbol]

_{depth} (d.gt)=∥1_{{gt>0}}⊙ (d−gt)∥₁. [Equation 1]

Where d represents the final depth map output by generating unit 100, gt represents ground truth, and ∥1_{{gt>0}}∥ represents valid depth pixels of ground truth data.

Adversarial loss is used to train the generating unit 100 and discriminating unit 102.

In particular, generating unit 100 minimizes it and discriminating unit 102 maximizes it.

Adversarial loss is as follows.

[symbol]

_{Adv}= [symbol] _{x˜p}_{ᵣ}₍ₓ₎ log D(.r)+ [symbol] _{z˜p}_{_{z}}_{(z)} log(1−D(G(z)). [Equation 2]

Where x is the real sample with distribution pᵣ(x) and z is the noise with distribution p_{z} (z). D (·) is the probability output of the discriminating unit 102 and G(·) is the output of the generating unit 100.

Consequently, the discriminating unit 102 attempts to maximize the adversarial loss.

[symbol]

_{Discriminator}= [symbol] _{Adv(D)} [Equation 3]

And, the generating unit 100 attempts to minimize the adversarial loss.

[symbol]

_{Generator}= [symbol] _{Adv(G)}+ [symbol] _{depth} [Equation 4]

According to the present embodiment, depth completion accuracy can be further improved by repeatedly updating weights of layers included in the first branch and the second branch through the loss function defined above.

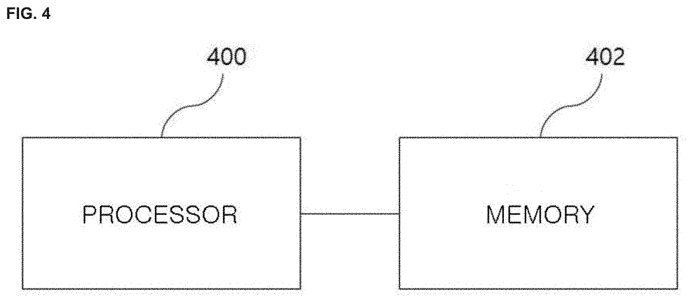

FIG. 4 is a diagram showing the configuration of a patch GAN-based depth completion apparatus according to the present embodiment.

As shown in FIG. 4, the depth completion apparatus according to the present embodiment may include a processor 400 and a memory 402.

The processor 400 may include a central processing unit (CPU) capable of executing a computer program or other virtual machines.

The memory 402 may include a non-volatile storage device such as a non-removable hard drive or a removable storage device. The removable storage device may include a compact flash unit, a USB memory stick, and the like. The memory 402 may also include volatile memory, such as various random-access memories.

The memory 402 according to the present embodiment stores program instructions executable by the processor for performing operations in a generating unit of a generative adversarial neural network comprising a first branch and a second branch based on an encoder-decoder comprising receiving an RGB image and a sparse image through a camera and LiDAR, generating a dense first depth map by processing color information of the RGB image through the first branch, generating a dense second depth map by up-sampling the sparse image through the second branch, generating a dense final depth map by fusing the first depth map and the second depth map, and determining, by a discriminating unit of the generative adversarial neural network, whether the final depth map is fake or real by dividing the final depth map and depth measurement data into a plurality of patches.

The embodiments of the present invention described above have been disclosed for illustrative purposes, and those skilled in the art having ordinary knowledge of the present invention will understand that various modifications, changes, and additions can be made within the spirit and scope of the present invention, and such modifications, changes, and additions will be considered to fall within the scope of the following claims.

1. A patch-GAN-based depth completion apparatus comprising:
a processor; and
a memory connected to the processor,
wherein the memory stores program instructions executable by the processor for performing operations in a generating unit of a generative adversarial neural network comprising a first branch and a second branch based on an encoder-decoder, comprising:
receiving an RGB image and a sparse image through a camera and LiDAR,
generating a dense first depth map by processing color information of the RGB image through the first branch,
generating a dense second depth map by up-sampling the sparse image through the second branch,
generating a dense final depth map by fusing the first depth map and the second depth map, and
determining, by a discriminating unit of the generative adversarial neural network, whether the final depth map is fake or real by dividing the final depth map and depth measurement data into a plurality of patches.

2. The patch-GAN-based depth completion apparatus of claim 1, wherein a first encoder of the first branch and a second encoder of the second branch include a plurality of layers,
wherein the first and second encoders include a convolutional layer and a plurality of residual blocks having a skip connection.

3. The patch-GAN-based depth completion apparatus of claim 2, wherein each layer of the first encoder is connected to each layer of the second encoder to help preserve rich features of the RGB image.

4. The patch-GAN-based depth completion apparatus of claim 1, wherein the discriminating unit divides the final depth map and the depth measurement data into matrices of N×N size, and evaluates whether each N×N patch is real or fake.

5. The patch-GAN-based depth completion apparatus of claim 4, wherein an image obtained by combining the RGB image with the final depth map and the depth measurement data is input to the discriminating unit.

6. A patch-GAN-based depth completion method in an apparatus including a processor and a memory comprising:
in a generating unit of a generative adversarial neural network comprising a first branch and a second branch based on an encoder-decoder comprising,
receiving an RGB image and a sparse image through a camera and LiDAR,
generating a dense first depth map by processing color information of the RGB image through the first branch,
generating a dense second depth map by up-sampling the sparse image through the second branch,
generating a dense final depth map by fusing the first depth map and the second depth map, and
determining, by a discriminating unit of the generative adversarial neural network, whether the final depth map is fake or real by dividing the final depth map and depth measurement data into a plurality of patches.

7. A non-transitory computer-readable medium storing a program for performing the method according to claim 6.
